(19) United States
(12) Patent Application Publication
(10) Pub. No.: US 2012/0123988 A1
(43) Pub. Date: May 17, 2012

(54) APPARATUS AND METHOD FOR GENERATING A CONTEXT-AWARE INFORMATION MODEL FOR CONTEXT INFERENCE

(76) Inventor: Su Myeon Kim, Hwaseong-si (KR)

(21) Appl. No.: 13/152,161

(22) Filed: Jun. 2, 2011

(30) Foreign Application Priority Data
Nov. 15, 2010 (KR) 10-2010-0113569

(51) Int. Cl. G06N 5/02

(52) U.S. Cl. 706/46; 706/59

(57) ABSTRACT

An apparatus and method for generating a context-aware information model are provided. A context-aware information model generation apparatus may generate a final model using at least one candidate context-aware information model that is determined based on sensor information. Additionally, the context-aware information model generation apparatus may infer a context of a user based on the generated final model.

### CROSS-REFERENCE TO RELATED APPLICATION(S)

This application claims the benefit under 35 U.S.C. §119(a) of Korean Patent Application No. 10-2010-0113569, filed on Nov. 15, 2010, in the Korean Intellectual Property Office, the entire disclosure of which is incorporated herein by reference for all purposes.

### BACKGROUND

1. Field

The following description relates to a context-aware information model generation apparatus and method, and more particularly, to an apparatus and method that may generate a context-aware information model that may be used to infer a context of a user that is using a context-aware information model generation apparatus.

2. Description of Related Art

Various services are used to track and/or monitor the environment and actions of a user. One method for monitoring a user is a context-aware service. A context-aware service may sense various contexts of a user and various contexts around the user, for example, a location, a speed, and the like. Based on the sensed contexts the context-aware service may infer a current context of user based on the sensed various contexts to provide a useful service to the user.

As an example, the context-aware service may sense a location or a speed of the user, and may infer that the user is riding in a car as inferred context. Accordingly, the service may provide information associated with the inferred context. In the example of the user riding in the car, the context-aware service may provide information about a rest area or a gas station close to the user, information associated with traffic, and the like.

However, because a large amount of services and information are used to infer a context of a user, it is difficult for a context-aware providing apparatus to find information and services required by the user. Furthermore, to more accurately infer context of a user, there is a desire to minutely express surroundings around the user. By minutely expressing the surroundings the amount of information used by the context-aware service increases.

One solution is inferring context of the user using context-aware information models that form a tree structure based on the information. However, because the context-aware information models increase in size as the amount of the information increases, a time and a complexity for inferring the context of the user may increase.

Accordingly, there is a desire for a technology that maintains the quality of context inference of a user while reducing the size and the complexity of the context-aware information models.

### SUMMARY

An apparatus for generating a context-aware information model, the apparatus including a candidate model determiner to determine at least one candidate context-aware information model from among a plurality of context-aware information models, based on sensor information, wherein the plurality of context-aware information models are classified into a plurality of categories, and a final model generator to generate a final model using the determined at least one candidate context-aware information model.

The candidate model determiner may comprise a comparing unit to determine whether the sensor information has changed by comparing the sensor information with previous sensor information, and a determining unit to determine, as the at least one candidate context-aware information model, at least one context-aware information model corresponding to the changed sensor information from among the plurality of context-aware information models, in response to the comparing unit determining that the sensor information has changed.

The final model generator may generate the final model by combining a plurality of candidate context-aware information models.

The apparatus may further comprise a sensor information receiver to receive sensor information comprising at least one of location information, transportation information, speed information, time information, weather information, illumination information, noise information, and traffic information.

The apparatus may further comprise a context inferring unit to extract context-aware information corresponding to the sensor information from the generated final model, and to infer a context of a user based on the extracted context-aware information.

The apparatus may further comprise an interface providing unit to provide a response to a query that is requested by at least one application, based on the final model. The apparatus may further comprise a database to categorize the plurality of context-aware information models into a first sub-category, to store the categorized context-aware information models, to categorize the first sub-category into a second sub-category, and to store the context-aware information models categorized as the second sub-category.

The database may group a plurality of pieces of model information regarding the context-aware information models categorized as the second sub-category, and store the plurality of pieces of grouped model information in such a way that common information from among the plurality of pieces of model information is shared.

The database may store tag information of each of the plurality of the context-aware information models.

In another aspect, there is provided a method of generating a context-aware information model, the method including determining at least one candidate context-aware information model from among a plurality of context-aware information models, based on sensor information, wherein the plurality of context-aware information models are classified into a plurality of categories, and generating a final model using the determined at least one candidate context-aware information model.

The determining may comprise determining whether the sensor information has changed by comparing the sensor information with previous sensor information, and determining, as the at least one candidate context-aware information model, at least one context-aware information model corresponding to the changed sensor information from among the plurality of context-aware information models, in response to determining that the sensor information has changed.

The generating may comprise generating the final model by combining a plurality of candidate context-aware information models.

The method may further comprise receiving sensor information comprising at least one of location information, transportation information, speed information, time information, weather information, illumination information, noise information, and traffic information.

The method may further comprise extracting context-aware information corresponding to the sensor information from the generated final model, and inferring a context of a user based on the extracted context-aware information.

The method may further comprise providing a response to a query that is requested by at least one application, based on the final model.

The method may further comprise managing a database configured to categorize the plurality of context-aware information models as a first sub-category, to store the categorized context-aware information models, to categorize the first sub-category as a second sub-category, and to store the context-aware information models categorized as the second sub-category.

The managing may comprise grouping a plurality of pieces of model information regarding the context-aware information models categorized as the second sub-category, and storing the plurality of pieces of grouped model information in such a way that common information from among the plurality of pieces of model information is shared.

The managing may comprise storing tag information of each of the plurality of context-aware information models.

In another aspect, there is provided a context-aware device, including a comparison unit to compare current sensor information with previous sensor information to determine whether sensor information has changed, and a determining unit to determine at least one context-aware information model based on changed sensor information.

The context-aware device may further comprise a final model generator to generate a final model by combining a plurality of context-aware information models to generate a single final context-aware information model.

The context-aware device may further comprise a context inference unit to extract context-aware information from the single final context-aware information model and to infer the context of a user of the context-aware device based on the extracted context-aware information.

Other features and aspects may be apparent from the following detailed description, the drawings, and the claims.

### BRIEF DESCRIPTION OF THE DRAWINGS

FIG. 1 is a diagram illustrating an example of a context-aware information model generation apparatus.

FIG. 2 is a diagram is a diagram illustrating an example of a candidate model determiner of FIG. 1.

FIG. 3 is a diagram illustrating an example of a time model.

FIG. 4 is a diagram illustrating an example of a transportation model.

FIG. 5 is a diagram illustrating an example of a location model.

FIG. 6 is a diagram illustrating an example of a final model.

FIG. 7 is a flowchart illustrating an example of a context-aware information model generation method.

FIG. 8 is a diagram illustrating an example of location models that are grouped.

FIG. 9 is a diagram illustrating an example of a location model using tag information.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

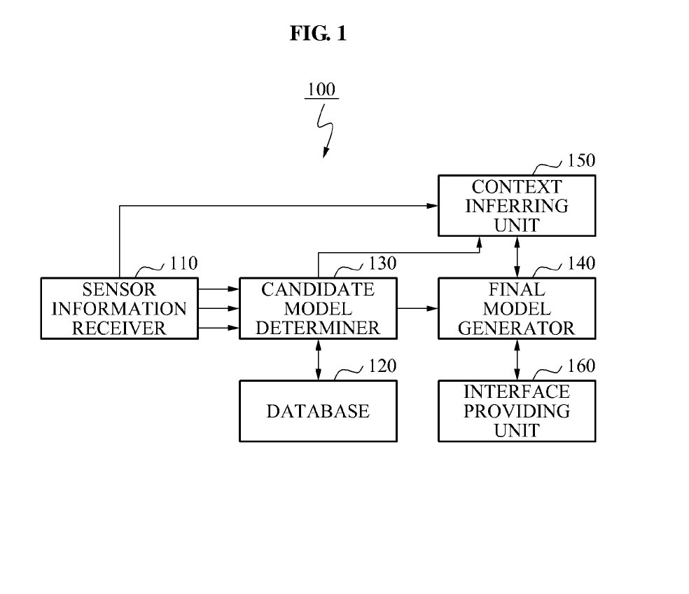

FIG. 1 illustrates an example of a context-aware information model generation apparatus.

Referring to FIG. 1, context-aware information model generation apparatus 100 includes a sensor information receiver 110, a database 120, a candidate model determiner 130, a final model generator 140, a context inferring unit 150, and an interface providing unit 160. The apparatus 100 may be or may be included in a terminal, for example, a computer, a mobile terminal, a smart phone, a laptop computer, a personal digital assistant, a tablet, an MP3 player, and the like.

The sensor information receiver 110 may receive sensor information. For example, the sensor information receiver 110 may receive sensor information via the Internet, via a sensor built in the context-aware information model generation apparatus 100, and the like. For example, the sensor information may include one or more of time information, transportation information, location information, speed information, weather information, illumination information, noise information, traffic information, and the like.

The database 120 may store a plurality of context-aware information models that are based on the sensor information. In this example, the plurality of context-aware information models may be classified for each category of the sensor information, and may be stored in the database 120. For example, the database 120 may store a “location” model that is based on location information, a “time” model that is based on time information, a “transportation” model that is based on transportation information, and the like.

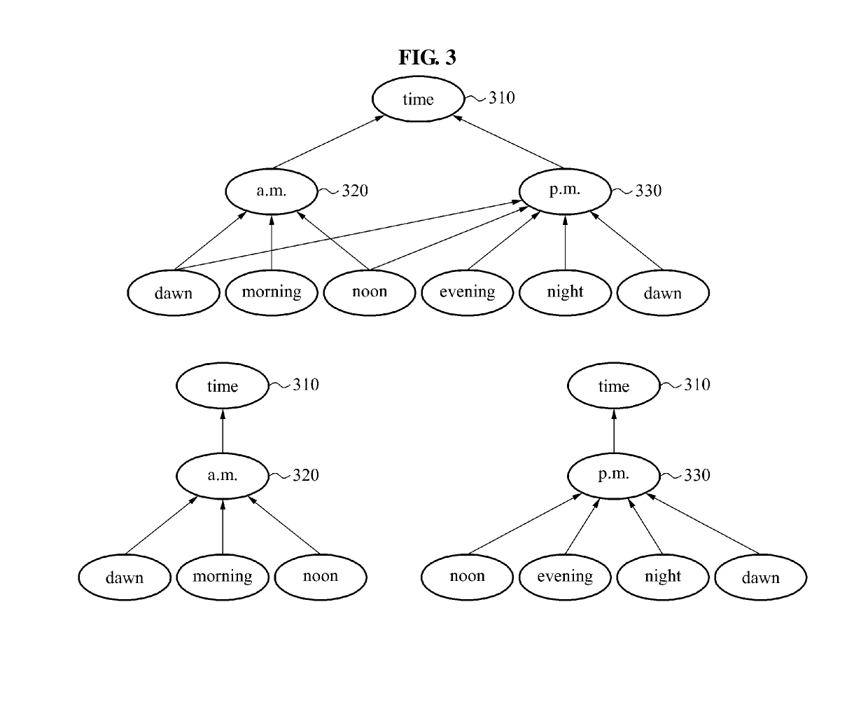

The database 120 may categorize the plurality of context-aware information models in sub-categories. For example, the database 120 may categorize context-aware information models in a first sub-category, and may store the categorized context-aware information models in a tree structure. As another example, the database 120 may categorize the plurality of context-aware information models into a plurality of sub-categories, for example, into a first sub-category and a second sub-category, and may store the context-aware information models categorized as the first sub-category and the second sub-category. As shown in the examples of FIGS. 3-5, the context-aware information models may be categorized into models “time”, “transportation”, and “location”, based on the sensor information, and the categorized models may be stored in the database 120.

FIG. 3 illustrates an example of a tree structure of a “time” model that is categorized into sub-categories.

Referring to FIG. 3, model “time” 310 is categorized into models “a.m.” 320, and “p.m.” 330, and the categorized models may be stored. The model “a.m.” 320 is categorized into models “dawn”, “morning”, and “noon”, and the categorized models may be stored. Additionally, the model “p.m.” 330 is categorized into models “noon”, “evening”, “night”, and “dawn”.

In this example, the models “a.m.” 320, and “p.m.” 330 correspond to a first sub-category, and the models “dawn”, “morning”, “noon”, “evening”, and “night” correspond to a second sub-category.

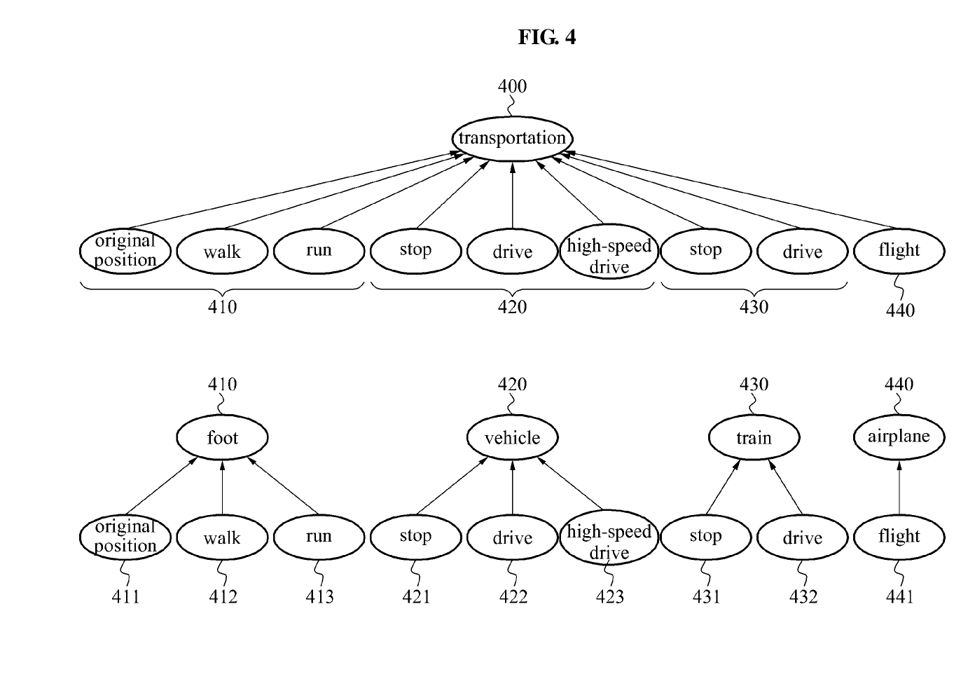

FIG. 4 illustrates an example of a tree structure of a “transportation” model that is categorized into sub-categories.

Referring to FIG. 4, model “transportation” 400 is categorized into models “foot” 410, “vehicle” 420, “train” 430, and “airplane” 440, and the categorized models may be stored.

The model “foot” 410 is categorized into models “original position” 411, “walk” 412, and “run” 413, and the categorized models may be stored. The model “vehicle” 420 is categorized into models “stop” 421, “drive” 422, and “high-speed drive” 423, and the categorized models may be stored. The model “train” 430 is categorized into models “stop” 431 and “drive” 432, and the categorized models may be stored. The model “airplane” 440 includes model “flight” 441.

In this example, the models “foot” 410, “vehicle” 420, “train” 430, and “airplane” 440 correspond to a first sub-category, and the models “original position” 411, “walk” 412, “run” 413, “stop” 421, “drive” 422, “high-speed drive” 423, “stop” 431, “drive”432, and “flight” 441 correspond to a second sub-category. In this example, transportation information may be determined, for example, using a location measurement device such as a Global Positioning System (GPS), and the like.

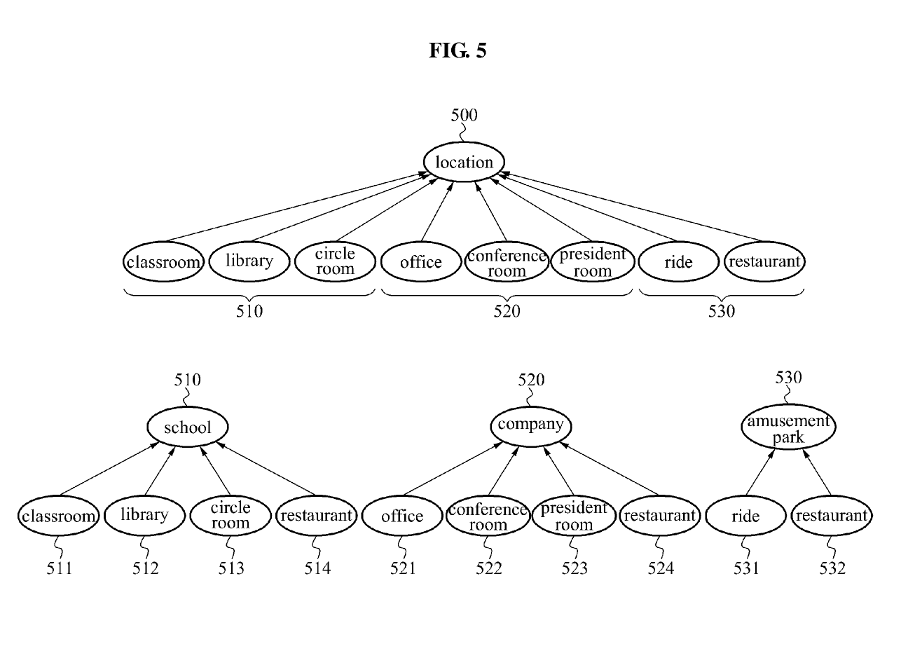

FIG. 5 illustrates an example of a tree structure of a “location” model that is categorized into sub-categories.

Referring to FIG. 5, model “location” 500 is categorized into models “school” 510, “company” 520, and “amusement park” 530, and the categorized models may be stored. In this example, the model “school” 510 is categorized into models “classroom” 511, “library” 512, “circle room” 513, and “restaurant” 514, and the categorized models may be stored. The model “company” 520 is categorized into models “office” 521, “conference room” 522, “president room” 523, and “restaurant” 524, and the categorized models may be stored. The model “amusement park” 530 is categorized into models “ride” 531 and “restaurant” 532, and the categorized models may be stored.

In this example, the models “school” 510, “company” 520, and “amusement park” 530 correspond to a first sub-category, and the models “classroom” 511, “library” 512, “circle room” 513, “restaurant” 514, “office” 521, “conference room” 522, “president room” 523, “restaurant” 524, “ride” 531, and “restaurant” 532 correspond to a second sub-category. In various examples herein, the context-aware information models databased based on the sensor information may be categorized into sub-categories, and may be stored in a tree structure in the database 120. In this example, location information may be determined, for example, using a location measurement from a device such as a GPS, and the like Referring again to FIG. 1, the candidate model determiner 130 may determine at least one candidate context-aware information model from among a plurality of context-aware information models, based on sensor information. For example, the candidate model determiner 130 may compare current sensor information with previous sensor information, and may determine, as a candidate context-aware information model, a context-aware information model that corresponds to the changed sensor information, based on a change in the sensor information.

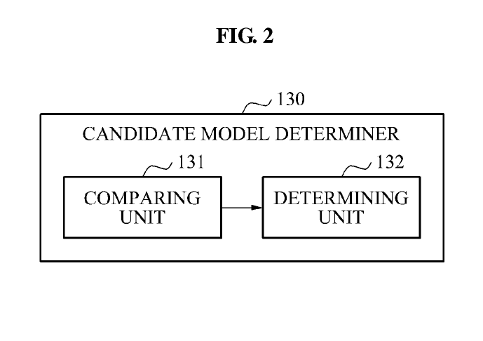

FIG. 2 illustrates an example of a candidate model determiner of FIG. 1.

Referring to FIG. 2, the candidate model determiner 130 includes a comparing unit 131 and a determining unit 132.

The comparing unit 131 may determine whether the sensor information has changed by comparing current sensor information with previous sensor information. In response to the comparing unit 131 determining that the sensor information has changed, the determining unit 132 may determine a context-aware information model that corresponds to the changed sensor information, from among a plurality of context-aware information models that are stored in the database 120.

As an example, in response to receiving current sensor information, the comparing unit 131 may determine whether the current sensor information is the same as the previous sensor information or similar to the previous sensor information. If the current sensor information is determined to be different from the previous sensor information, the comparing unit 131 may determine that the sensor information has changed. For example, if time information is used as sensor information, and a current time information indicates “p.m.” and a previous time information indicates “a.m.”, the comparing unit 131 may compare the current time information with the previous time information, and determine that the sensor information has changed from “a.m.” to “p.m.”. Accordingly, the determining unit 132 may determine model “p.m.” from among the categories of model “time” as a candidate context-aware information model that corresponds to the changed sensor information.

As another example, if transportation information is used as sensor information, and current transportation information indicates “Vehicle” and a previous transportation information indicates “Foot”, the comparing unit 131 may compare the current transportation information with the previous transportation information, and determine that the sensor information has changed from “Foot” to “Vehicle”. Accordingly, the determining unit 132 may determine model “vehicle” from among the categories of model “transportation” as a candidate context-aware information model that corresponds to the changed sensor information.

As another example, if location information is used as sensor information, and current location information includes a coordinate or a name of a place indicating a location of an amusement park and a previous location information includes a coordinate or a name of a place indicating a location of a school, the comparing unit 131 may compare the current location information with the previous location information, and determine that the sensor information has changed from “School” to “Amusement park”. Accordingly, the determining unit 132 may determine “amusement park” from among the categories of model “location” as a candidate context-aware information model that corresponds to the changed sensor information.

If the current sensor information is determined to be the same as the previous sensor information, the comparing unit 131 may determine that the sensor information has not changed. The context inferring unit 150 may infer context of a user based on a previous context-aware information model. For example, the previous context-aware information model may include a previously determined final model.

The final model generator 140 may generate a final model using the determined at least one candidate context-aware information model. For example, if a single candidate context-aware information model is determined, the final model generator 140 may generate a final model that is based on the single candidate context-aware information model.

If a plurality of candidate context-aware information models are determined, the final model generator 140 may generate a final model by combining the plurality of candidate context-aware information models. In this example, the final model generated by combining the plurality of candidate context-aware information models may have a tree structure that is based on a root.

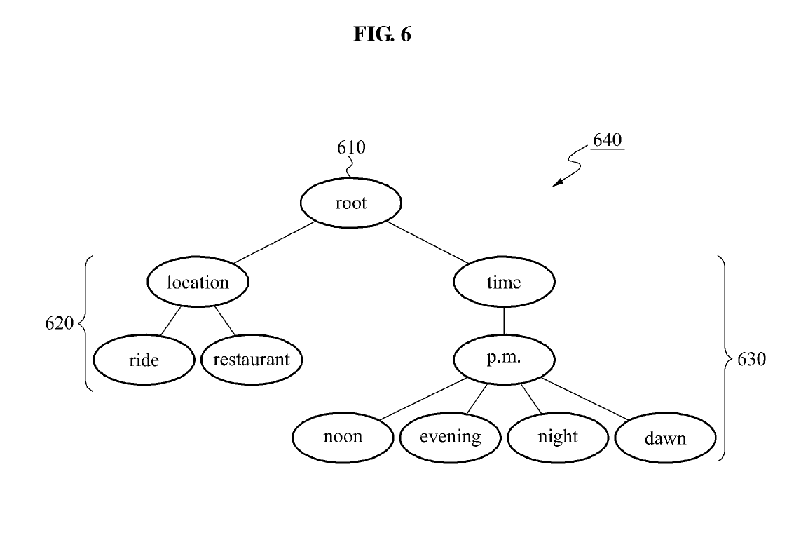

FIG. 6 illustrates an example of a final model.

Referring to FIG. 6, models “time” and “location” are determined as candidate context-aware information models. In this example, the final model generator 140 may generate a final model by combining the models “time” and “location”.

For example, the candidate model determiner 130 may verify that the context-aware information model generation apparatus 100 is located in an amusement park based on location information. Accordingly, the candidate model determiner 130 may determine the model “amusement part” 530 from among the categories of model “location” 500 of FIG. 5, as candidate context-aware information models. As another example, the candidate model determiner 130 may determine model “p.m.” from among the categories of model “time” as candidate context-aware information model, based on the tine information. Referring back to FIG. 6, the final model generator 140 may generate a final model 640 by combining models “amusement park” 620 and “p.m.” 630. Accordingly, the final model 640 may include the models “amusement park” 620 and “p.m.” 630 that form a tree structure based on a root 610.

As described herein, the final model generator 140 may reduce the size of a model by generating the final model using the models “amusement park” and “p.m.” that are determined from among the categories of models “location” and “time” based on sensor information. Accordingly, as the size of the model is reduced, a memory capacity used for context inference, and a processing time taken to perform context inference are also reduced.

The context inferring unit 150 may extract context-aware information that corresponds to the sensor information, and may infer a context of a user based on the extracted context-aware information. For example, the context inferring unit 150 may infer context by extracting context-aware information from the generated final model. For example, if location information includes a coordinate or a name of a place of a “restaurant”, and if the time information indicates “noon”, the context inferring unit 150 may extract context-aware information such as information indicating “lunch in restaurant” based on a final model. As another example, the context inferring unit 150 may infer a context that “a user is eating lunch in a restaurant of an amusement park”, based on the extracted context-aware information.

The interface providing unit 160 may provide a response to a query that is requested by at least one application, based on the generated final model. For example, various types of applications may be installed in advance in the context-aware information model generation apparatus 100. The applications installed in advance may include, for example, an alarm application, a game application, a traffic information application, and the like.

As an example, if an alarm is set to 7 a.m., and the time turns to or is about to turn to 7 a.m., an alarm application may transmit to the interface providing unit 160, a query asking whether a user is in a wake state or a sleep state. In response to the query, the interface providing unit 160 may transmit a response message to the alarm application indicating whether the user is in the wake state or the sleep state. The alarm application may enable the set alarm to be turned on or off, based on the response message. For example, if the user is in the wake state, the alarm application may turn off the alarm at 7 a.m., because there is no need to ring the alarm. As another example, if the user is in the sleep state, the alarm application may ring the alarm at 7 a.m.

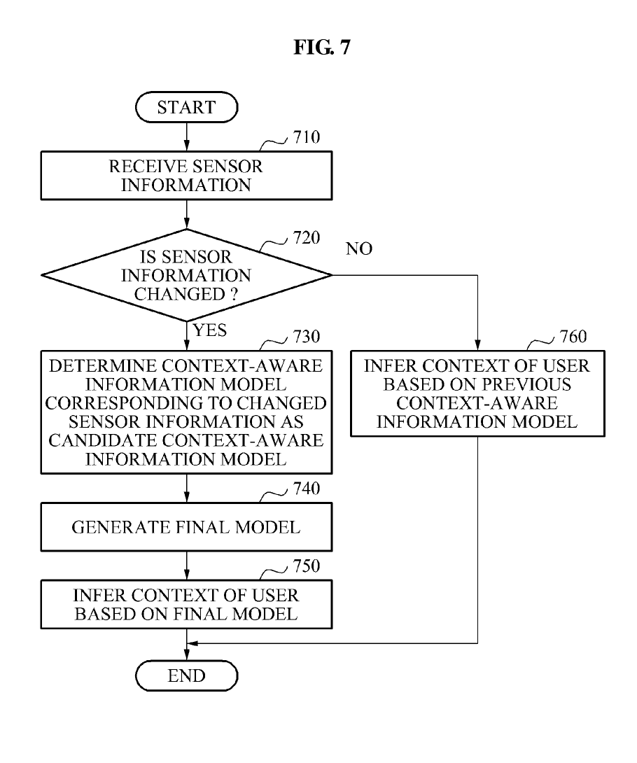

FIG. 7 illustrates an example of a context-aware information model generation method.

Referring to FIG. 7, in 710, the sensor information receiver 110 receives sensor information from a sensor and/or the Internet. For example, the sensor information may include at least one of time information, transportation information, location information, speed information, weather information, illumination information, noise information, traffic information, and the like.

In 720, the information determining unit 131 determines whether the sensor information has changed by comparing current sensor information with previous sensor information. In response to determining that the sensor information has not changed, the context inferring unit 150 infers a context of a user based on a previous context-aware information model, in 760.

Conversely, in response to determining that the sensor information has changed, the determining unit 132 determines a context-aware information model that corresponds to the changed sensor information from among a plurality of context-aware information models stored in the database 120, in 730.

In 740, the final model generator 140 generates a final model based on the determined candidate context-aware information model.

For example, if a plurality of candidate context-aware information models are determined, the final model generator 140 may combine the plurality of candidate context-aware information models, and may generate a final model with a tree structure.

As another example, if a single candidate context-aware information model is determined, the final model generator 140 may generate a final model based on the single candidate context-aware information model.

In 750, the context inferring unit 150 extracts context-aware information that corresponds to the sensor information from the generated final model, and infers a context of a user based on the extracted context-aware information.

As described herein, the final model may be generated using context-aware information models that are based on the sensor information from among the plurality of context-aware information models that are classified for each category and stored in the database 120.

Hereinafter, an example of sharing a common category among context-aware information models is described.

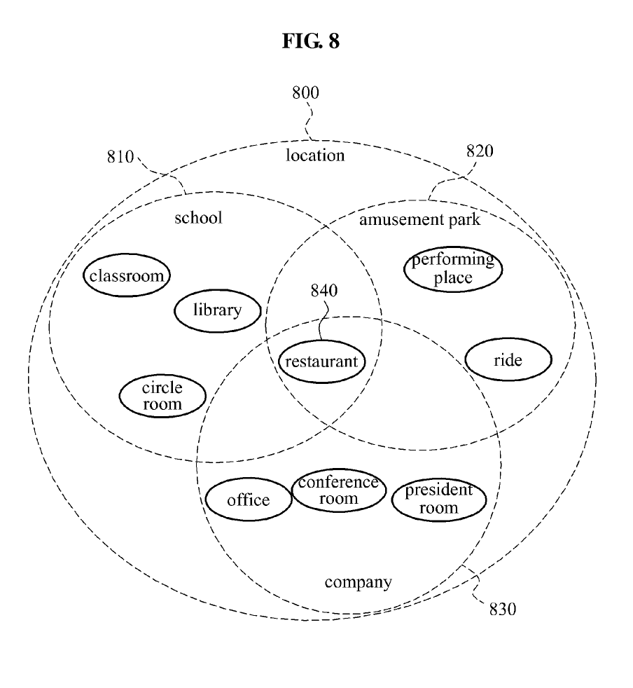

FIG. 8 illustrates an example of “location” models that are grouped.

Referring to FIG. 8, the database 120 may group a plurality of pieces of model information regarding the context-aware information models that are categorized as a first sub-category, and may store the plurality of pieces of grouped model information such that common information from among a plurality of pieces of model information regarding context-aware information models categorized as a second sub-category are shared.

Referring to FIG. 8, model “location” 800 may be grouped into models “school” 810, “amusement part” 820, and “company” 830, as the first sub-category, and the grouped location models may be stored in the database 120. In this example, information regarding model “restaurant” 840 is common information from among pieces of model information for each of the models “school” 810, “amusement part” 820, and “company” 830. Accordingly, the database 120 may group the pieces of model information, and may store the pieces of grouped model information, so that the information regarding the models “restaurant” 840 may be shared among the models “school” 810, “amusement part” 820, and “company” 830, as illustrated in FIG. 8.

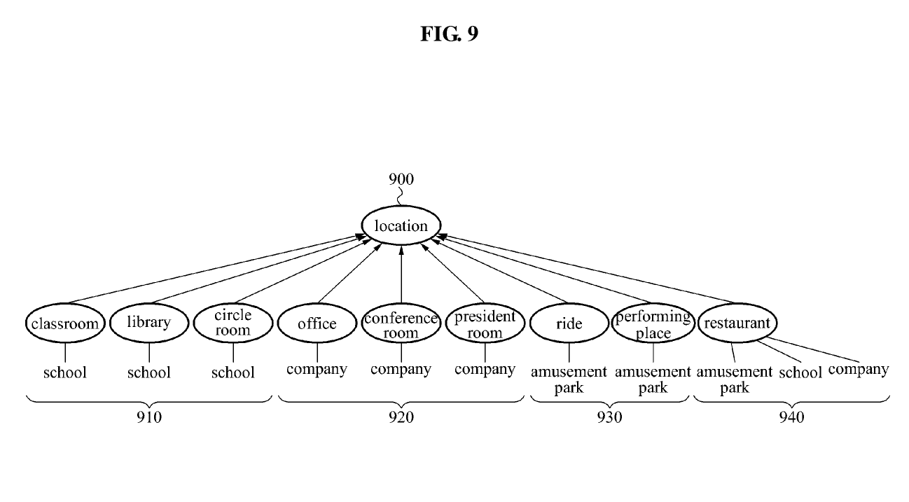

FIG. 9 illustrates an example of a “location” model using tag information.

Referring to FIG. 9, a plurality of pieces of model information pertaining to models “location” 900 may each include tag information. For example, tag information 910 of models “classroom”, “library”, and “circle room” may be used to identify a model “school”. Additionally, tag information 920 of models “office”, “conference room”, and “president room” may be used to identify model “company”. Furthermore, tag information 930 of models “ride” and “performing place” may be used to identify model “amusement park.

In this example, tag information 940 of model “restaurant” is common information of the models “school”, “company”, and “amusement park”, and may be used to identify the models “school”, “company”, and “amusement park”. In other words, tag information of common information may include multiple pieces of information corresponding to models that share the common information. Accordingly, the candidate model determiner 130 may determine at least one of the plurality of context-aware information models stored in the database 120, by filtering pieces of tag information based on location information. Additionally, the final model generator 140 may generate a final model based on the determined at least one candidate context-aware information model.

The above-described context-aware information model generation apparatus may be modulated and loaded in a terminal For example, the terminal may include a portable mobile terminal, for example, a smart phone, a digital multimedia broadcasting (DMB) phone, a navigation device, and the like.

The sensors used by the terminal may include various sensors for detecting motion such as a GPS sensor and the like.

According to various examples, it is possible to generate a final model using at least one candidate context-aware information model that is determined based on sensor information from among a plurality of context-aware information models, thereby reducing the size and the operation complexity of the plurality of context-aware information models.

Additionally, it is possible to infer a context of a user based on sensor information and a final model, thereby improving a context-awareness performance, without influence on a quality of context inference.

Furthermore, it is possible to provide context inference even in a terminal with a smaller memory or a lower processing speed, by using a final model generated based on sensor information.

The processes, functions, methods, and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of computer-readable storage media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for generating a context-aware information model, the apparatus comprising:
a candidate model determiner to determine at least one candidate context-aware information model from among a plurality of context-aware information models, based on sensor information, wherein the plurality of context-aware information models are classified into a plurality of categories; and
a final model generator to generate a final model using the determined at least one candidate context-aware information model.

2. The apparatus of claim 1, wherein the candidate model determiner comprises:
a comparing unit to determine whether the sensor information has changed by comparing the sensor information with previous sensor information; and
a determining unit to determine, as the at least one candidate context-aware information model, at least one context-aware information model corresponding to the changed sensor information from among the plurality of context-aware information models, in response to the comparing unit determining that the sensor information has changed.

3. The apparatus of claim 1, wherein the final model generator generates the final model by combining a plurality of candidate context-aware information models.

4. The apparatus of claim 1, further comprising:
a sensor information receiver to receive sensor information comprising at least one of location information, transportation information, speed information, time information, weather information, illumination information, noise information, and traffic information.

5. The apparatus of claim 1, further comprising:
a context inferring unit to extract context-aware information corresponding to the sensor information from the generated final model, and to infer a context of a user based on the extracted context-aware information.

6. The apparatus of claim 1, further comprising:
an interface providing unit to provide a response to a query that is requested by at least one application, based on the final model.

7. The apparatus of claim 1, further comprising:
a database to categorize the plurality of context-aware information models into a first sub-category, to store the categorized context-aware information models, to categorize the first sub-category into a second sub-category, and to store the context-aware information models categorized as the second sub-category.

8. The apparatus of claim 7, wherein the database groups a plurality of pieces of model information regarding the context-aware information models categorized as the second sub-category, and stores the plurality of pieces of grouped model information in such a way that common information from among the plurality of pieces of model information is shared.

9. The apparatus of claim 7, wherein the database stores tag information of each of the plurality of the context-aware information models.

10. A method of generating a context-aware information model, the method comprising:
determining at least one candidate context-aware information model from among a plurality of context-aware information models, based on sensor information, wherein the plurality of context-aware information models are classified into a plurality of categories; and
generating a final model using the determined at least one candidate context-aware information model.

11. The method of claim 10, wherein the determining comprises:
determining whether the sensor information has changed by comparing the sensor information with previous sensor information; and
determining, as the at least one candidate context-aware information model, at least one context-aware information model corresponding to the changed sensor information from among the plurality of context-aware information models, in response to determining that the sensor information has changed.

12. The method of claim 10, wherein the generating comprises generating the final model by combining a plurality of candidate context-aware information models.

13. The method of claim 10, further comprising:
receiving sensor information comprising at least one of location information, transportation information, speed information, time information, weather information, illumination information, noise information, and traffic information.

14. The method of claim 10, further comprising:
extracting context-aware information corresponding to the sensor information from the generated final model, and inferring a context of a user based on the extracted context-aware information.

15. The method of claim 10, further comprising:
providing a response to a query that is requested by at least one application, based on the final model.

16. The method of claim 10, further comprising:
managing a database configured to categorize the plurality of context-aware information models as a first sub-category, to store the categorized context-aware information models, to categorize the first sub-category as a second sub-category, and to store the context-aware information models categorized as the second sub-category.

17. The method of claim 16, wherein the managing comprises grouping a plurality of pieces of model information regarding the context-aware information models categorized as the second sub-category, and storing the plurality of pieces of grouped model information in such a way that common information from among the plurality of pieces of model information is shared.

18. The method of claim 16, wherein the managing comprises storing tag information of each of the plurality of context-aware information models.

19. A context-aware device, comprising:
a comparing unit to compare current sensor information with previous sensor information to determine whether sensor information has changed; and
a determining unit to determine at least one context-aware information model based on changed sensor information.

20. The context-aware device of claim 19, further comprising:
a final model generator to generate a final model by combining a plurality of context-aware information models to generate a single final context-aware information model.

21. The context-aware device of claim 20, further comprising:
a context inference unit to extract context-aware information from the single final context-aware information model and to infer the context of a user of the context-aware device based on the extracted context-aware information.
